(19) United States
(12) Patent Application Publication
(10) Pub. No.: US 2011/0051416 A1
(43) Pub. Date: Mar. 3, 2011

(54) LIGHTING SYSTEM

(75) Inventors: Stefan Marcus Verbrugh, Eindhoven (NL); Cornelis Jojakim Jalink, Eindhoven (NL)

(73) Assignee: KONINKLIJKE PHILIPS ELECTRONICS N.V., EINDHOVEN (NL)

(21) Appl. No.: 12/988,028

(22) PCT Filed: Apr. 20, 2009
(86) PCT No.: PCT/IB09/51613

§ 371 Date: Oct. 15, 2010

(30) Foreign Application Priority Data
Apr. 23, 2008 (EP) 08155010.5

(51) Int. Cl. F21V 5/00; F21V 11/00

(52) U.S. Cl. 362/235

(57) ABSTRACT

The present invention relates the field of illumination devices, in particular to a lighting system (1) comprising an elongated light guiding plate (2), comprising at least one light source (3). The light source (3) is enclosed in the light guiding plate (2). Furthermore, the light guiding plate (2) has at least one curvature (R).

### FIELD OF THE INVENTION

The present invention relates the field of illumination devices, in particular to a lighting system comprising an elongated light guiding plate.

### BACKGROUND OF THE INVENTION

In the field of lighting for interior and exterior use, there is an increasing need to integrate the lighting systems as unobtrusively as possible. This enables architects and interior designers to, by means of lighting, create a style that clearly distinguishes one building from another or one room from another. The commonly used fluorescent lamp fixtures usually have a thickness of about 5 cm. It is, however, expected that these fluorescent lamp fixtures will be replaced by thin, LED-based illumination systems within a near future. Many of these illumination systems, typically, have a thickness of less than 10 mm.

In office environments, it is often desired to provide direct lighting for workspaces and indirect lighting for providing general lighting. Light fixtures with indirect and direct lighting have been introduced in order to provide general lighting conditions that are considered to improve productivity and occupant satisfaction. Even though these parameters are hard to quantify, the benefits are said to be significant. Moreover, for fulfilling the requirements for office lighting, collimation angles of typically 2×45° are required. Collimation of the light reduces glare. In addition, to reduce glare, the luminance for angles above 65° should be below 1000 cd/m2. Thus, it is desired that the thin illumination systems fulfill these glare requirements and these general lighting conditions.

However, when these lighting systems are suspended in, for example, an office environment or outside a building, the lighting system elastically bends due to its own weight. In FIG. 1, there is shown an example of such a lighting system, when not suspended or stressed in any way.

In FIG. 2, there is illustrated how such a lighting system elastically bends due to its own weight, when suspended to, for example, the roof of an office space. As a result, the optical properties of the lighting system change due to the elastic deformation. For example, glare requirements and/or conditions for indirect and direct lighting may not be fulfilled.

In CN 1959195, there is disclosed a lighting system, comprising LEDs, a curved light guide plate and a power supply. The LEDs are powered by the power supply and are arranged at the periphery of the light guide plate to emit light into the light guide plate. A pattern on the light guide plate is used to extract light from the light guide plate.

Hence, there is a need for thin lighting systems that are mechanically stiff.

### SUMMARY OF THE INVENTION

In EP07106023.0 and EP06122321.0, which were not publicly available at the earliest date of filing of the present application, there are disclosed lighting systems that fulfill the initially mentioned glare requirements and general lighting conditions.

An object of the present invention is to alleviate at least one of the problems of prior art.

This object is met by the lighting system as set forth in the appended independent claim 1. Specific embodiments are defined in the dependent claims.

According to an aspect of the invention, there is provided a lighting system, comprising an elongated light guiding plate, comprising at least one light source. The light source is enclosed in the light guiding plate. Furthermore, the light guiding plate has at least one curvature. An advantage with the lighting system according to the present invention is that said at least one curvature of the light guiding plate improves the mechanical stiffness thereof.

An insight forming a basis for the present invention, it that the shape of the light guiding plate may be arranged such as to improve the mechanical stiffness of the lighting system. As a result, there is provided a lighting system, comprising an elongated light guiding plate (or light guiding lamina), comprising at least one light source, arranged within the light guiding plate. Furthermore, the light guiding plate is curved about at least one axis, i.e. the light guiding plate is formed such as to form a part of a surface of a cylinder, an ellipsoid, a cone or the like. Advantageously, the lighting system is arranged to have an improved mechanical stiffness as compared to conventional lighting systems.

Any references to “up”, “down”, “top”, “bottom”, “upper”, “lower”, “above”, “under”, etc. are to be taken with reference to the orientation of the lighting system and are merely used in order to increase clarity. It shall, hence, be noted that the lighting system may be tilted in any particular angle, such that these references may need to be reinterpreted in relation to the actual position of the particular lighting system, presently being observed.

Moreover, in embodiments of the lighting system according to the present invention, said at least one light source comprises a plurality of light sources, distributed in the light guiding plate. In other words, said plurality of light sources are arranged spaced from each other such as to provide a light distribution, e.g. an even light distribution, within the light guiding plate. Preferably, the light sources are evenly spread (or distributed) in the light guiding plate.

In an embodiment of the present invention, there is provided a lighting system, wherein the light guiding plate is longitudinally elongated and has at least one laterally facing light emitting surface. In other words, the light emitting surface is facing a direction of a normal to the light guiding plate.

In other embodiments of the present invention, there is provided a lighting system, wherein said light source may be arranged to face a longitudinal direction of the light guiding plate, i.e. the light source(s) may be arranged to emit light such that it may be distributed within the light guiding plate.

Furthermore, in embodiments of the lighting system according to the present invention, said at least one curvature may be curved about a longitudinal axis of the light guiding plate and may be arranged such as to contribute to mechanical stiffness of the light guiding plate.

According to still other embodiments of present lighting system, said light source or said plurality of light sources may be arranged to face a longitudinal, center plane of the light guiding plate, i.e. the light source(s) may be arranged to emit light such that the light may be distributed by (coupled out of) the light guiding plate.

In another embodiment according to the present invention, there is provided a lighting system, wherein the curvature is concave with respect to said at least one light emitting surface. In a case where the lighting system is suspended such that the lighting system is substantially horizontally oriented, the curvature is concave with respect to an underside of the lighting system.

Furthermore, in embodiments of the lighting system according to the present invention, said at least one curvature satisfies the following relationship

$$R > \frac{d}{\sqrt{{n}^{2} - 1} - 1} ,$$

where d is the thickness of the light guiding plate and n is the refractive index of the light guiding plate. In this manner, the light guiding properties of the lighting system may be conserved, i.e. conditions for fulfilling glare requirements and/or general lighting may remain fulfilled even though the light guiding plate has a curvature. Generally speaking, a curvature destroys the total internal reflection (TIR). However, if the above expression is fulfilled, there is still TIR. If the radius of curvature R not fulfills the expression above, some light beams no longer are kept within the plate by TIR. Instead, these light beams leave the plate at unpredictable and/or uncontrolled angles. Light that leaves the plate at these unpredictable and/or uncontrolled angles may cause glare. The above expression is derived under the assumption that in-coupling of light in the plate occurs at any incident angle.

In another embodiment of the lighting system according to the present invention, the thickness of the light guiding plate may be less than 10 mm, preferably less than 5 mm, most preferably less than 2 mm. In this manner, since less material is consumed, low cost and low weight is provided. It is to be noted that the thickness of the light guiding plate does not limit the size of the light emitting surface.

Moreover, in still other embodiments of the lighting system according to the present invention, said light source comprises an LED, a laser, a laser diode or the like. The lighting system may comprise LEDs (or the like) of one type or may comprise LEDs (or the like) of different types, i.e. of different color, emission pattern, brightness, etc.

In a further embodiment of the lighting system according to the present invention, the light guiding plate may have two curvatures arranged to form the light guiding plate into a saddleback surface. In this manner, the mechanical stiffness of the lighting system is improved in two directions, i.e. in the directions of the axes about which the curvatures are curved. This is particularly useful when the overall size of the lighting system is substantially in the form of a square. Also, as a result of the different curvatures of the light emitting surface, different beam widths may be provided at different locations at the light emitting surface. Moreover, for some applications, a saddleback surface may provide an appealing design.

The light guiding plate may have a plurality of curvatures in yet other embodiments of the present invention. It is preferred that said plurality of curvatures has the same radius and is arranged to form the light guiding plate into a periodic shape, preferably a sinusoidal shape. Advantageously, the total height of the lighting system may be less than for a lighting system comprising a light guiding plate with only one curvature, under the condition that substantially each radius of the curvatures of the light guiding plate with a plurality of curvatures is equal to or approximately equal to the radius of the curvature of the light guiding plate with only one curvature and that the size of the lighting systems is equal. A further advantage is that a variety of products may be based on the same basic component, which in this case would be a flat light guide plate, comprising LEDs. By shaping the basic component different light distributions may be achieved. In this manner, cost of manufacturing may be less (high volumes of the basic component) and cost of logistics may be less (forming of the lighting system may be performed at a location different from the place of manufacturing and flat lighting system may require less space than curved lighting systems).

Further features of, and advantages with, the present invention will become apparent when studying the appended claims and the following description. Those skilled in the art realize that different features of the present invention may be combined to create embodiments other than those described in the following, without departing from the scope of the present invention.

### BRIEF DESCRIPTION OF THE DRAWINGS

The various aspects of the invention, including its particular features and advantages, will be readily understood from the following detailed description and the accompanying drawings, in which:

FIG. 1 is a cross-sectional, side view of a prior art lighting system,

FIG. 2 is a further cross-sectional, side view of the prior art lighting system of FIG. 1,

FIG. 3 is a perspective view of the lighting system according to an embodiment of the present invention,

FIG. 4 is a perspective view of the lighting system according to another embodiment of the present invention, wherein the lighting guiding plate has two curvatures, and

FIG. 5 is a perspective view of the lighting system according to a further embodiment of the present invention, wherein the light guiding plate has a plurality of curvatures.

### DETAILED DESCRIPTION OF EMBODIMENTS

Throughout the following description similar reference numerals have been used to denote similar elements, parts, items or features, when applicable.

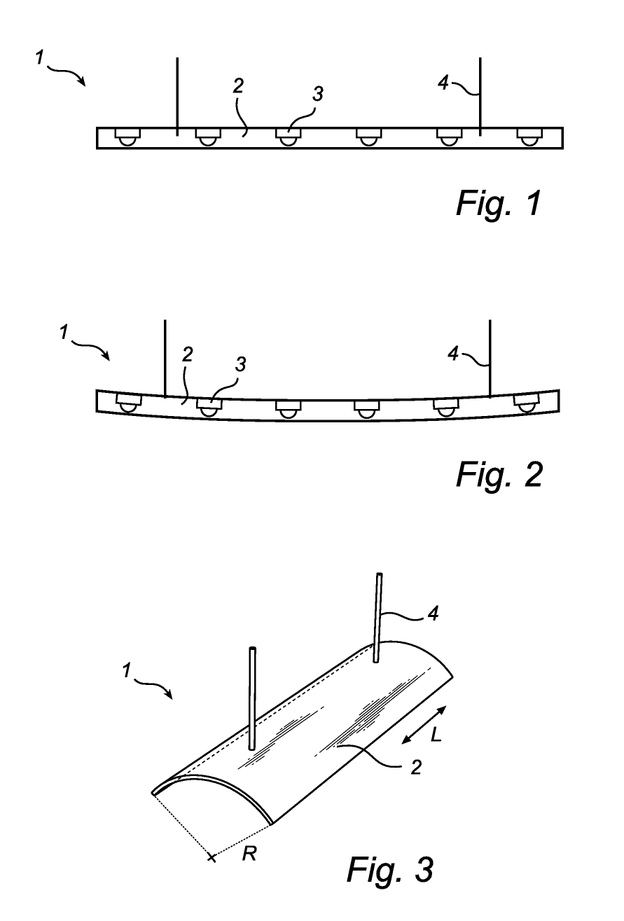

FIG. 1 shows a prior art lighting system as described above.

In FIG. 2, there is shown the prior art lighting system according to FIG. 1, when suspended, as described above.

Referring to FIG. 3 there is demonstrated an exemplifying embodiment of the lighting system according to the present invention. The size of the lighting system is, typically, 100×20 cm and the thickness is approximately 5 mm. As a result, the light emitting surface is approximately 100×20 cm. The lighting system 1 comprises a light guiding plate 2, which encloses a plurality of LEDs 3. The LEDs are arranged to face in a direction along a normal to the light guiding plate.

In a preferred, alternative example of the lighting system according to the present invention, the LEDs are arranged to face in a direction along a longitudinal axis of the light guiding plate (not shown). Advantageously, the brightness of the LEDs may not be directly visible and the creation of a lighting system having a small thickness is facilitated. In this manner, the light from the LEDs is guided within the light guiding plate. In other aspects, this preferred, alternative example of the lighting system according to the present invention is similar to the lighting systems according to FIGS. 3 to 5.

In fact, the LEDs may be oriented in any direction as required by any specific application, for example some LEDs may face in one direction along the normal, while other LEDs may face the opposite direction.

Moreover, with reference to FIG. 3, the light guiding plate 2 is curved about an axis running parallel to a longitudinal axis (direction L) of the light guiding plate. The lighting system is suspended by means of fastening means 4, such as bolts, wires, brackets, etc. With respect to an underside of the lighting system, the curvature is concave and has a curvature R. It is preferred that following expression holds for the curvature R:

$$R > \frac{d}{\sqrt{{n}^{2} - 1} - 1} ,$$

where d is the thickness of the light guiding plate 2 and n is the refractive index of the light guiding plate 2. A curvature R, satisfying the expression above, may be such that it hardly (or not at all) affects the light guiding operation, i.e. glare requirement and other general lighting conditions may still be fulfilled. Advantageously, the lighting system according to FIG. 3 may cause some collimation of the light emitted from the LED within the light guiding plate. However, the collimation provided by the curvature of the lighting system may usually only function as a complement to or enhancement of means for collimation of the light from the lighting system, which means for collimation is arranged within the light guiding plate.

In another embodiment of the lighting system according to FIG. 3, the curvature may be concave with respect to the side at which the fastening means 4 is attached to the lighting system, i.e. with respect to an upper side of the lighting system. In this case, the upper side of the lighting system may be the light emitting side or both the underside and the upper side may be arranged to be capable of emitting light.

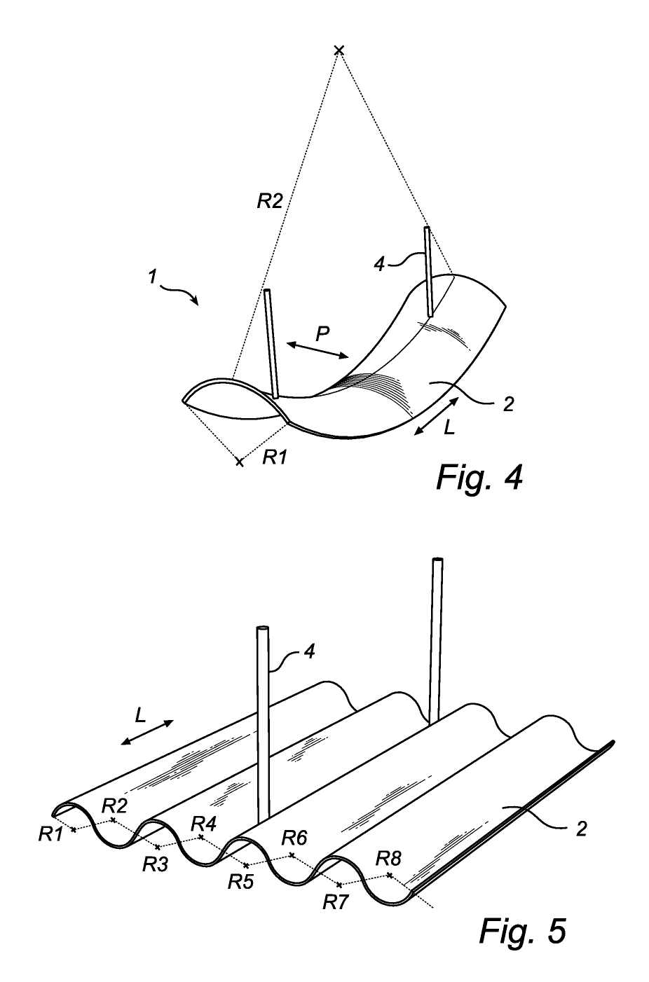

FIG. 4 shows another exemplifying embodiment of the lighting system according to the present invention, wherein the lighting guiding plate 2 has two curvatures. In other aspects, the lighting system according to FIG. 4 is similar to the lighting system according to FIG. 3. Therefore, explanations of parts/elements or alike of the lighting system in FIG. 4 that are equal or similar to parts/elements or alike of the lighting system in FIG. 3 have been omitted. A first curvature R1 of the light guiding plate is arranged to (preferably in a plastic manner) bend the light guiding plate about a longitudinal axis running parallel to the longitudinal axis of the light guiding plate (direction L), whereas a second curvature R2 of the light guiding plate is arranged to, preferably plastically, bend the light guiding plate about an axis that is substantially perpendicular to the longitudinal axis of the light guiding plate (direction P), i.e. about an axis running parallel to a lateral axis through the plane of the light guiding plate. A center of the curvature R1 is located on the opposite side of the lighting system as compared to a center of the curvature R2. The first and second curvature R1, R2 may be different from each other or may be equal to each other. In this manner, a saddleback shaped light guiding plate is formed by the first and second curvature of the light guiding plate. It may be preferred that both R1 and R2 fulfill the relation above.

With reference to FIG. 5, there is demonstrated a further exemplifying embodiment of the lighting system according to the present invention, wherein the light guiding plate has a plurality of curvatures. In other aspects, the lighting system according to FIG. 5 is similar to the lighting system according to FIG. 3. Therefore, explanations of parts/elements or alike of the lighting system in FIG. 5 that are equal or similar to parts/elements or alike of the lighting system in FIG. 3 have been omitted. In this example, the light guiding plate has a number of curvatures R1, R2, R3, R4, R5, R6, R7 and R8, which alternately are concave or convex with respect to a light emitting side of the lighting system. It may be preferred that R1-R8 fulfill the relation above. The curvatures R1 to R8 may be different from each other or may be equal to each other. Curvature R1 of the light guiding plate is arranged to run along the longitudinal direction (direction L) of the light guiding plate. The curvature R1 may be constant along the longitudinal direction of the light guiding plate or may vary along the longitudinal direction of the light guiding plate. Variation of the curvature along any direction may be applied to any embodiment of the lighting system according to the present invention.

Even though the invention has been described with reference to specific exemplifying embodiments thereof, many different alterations, modifications and the like will become apparent for those skilled in the art. The described embodiments are therefore not intended to limit the scope of the invention, as defined by the appended claims.

1. A lighting system (1), comprising an elongated light guiding plate (2), comprising at least one light source (3), enclosed in the light guiding plate (2), wherein the light guiding plate (2) has at least one curvature (R).

2. The lighting system (1) according to claim 1, wherein said at least one light source (3) comprises a plurality of light sources (3), distributed in the light guiding plate (2).

3. The lighting system (1) according to claim 1 wherein the light guiding plate (2) is longitudinally elongated and has at least one laterally facing light emitting surface.

4. The lighting system (1) according to claim 3, wherein said at least one curvature (R) is curved about a longitudinal axis of the light guiding plate (2) and is arranged such as to contribute to mechanical stiffness of the light guiding plate (2).

5. The lighting system (1) according to claim 3, wherein said at least one light source (3) is arranged to face a longitudinal direction of the light guiding plate (2).

6. The lighting system (1) according to claim 1 wherein the curvature (R) is concave with respect to said at least one light emitting surface.

7. The lighting system (1) according to claim 1 wherein said at least one curvature (R) satisfies the following relationship:
$$R > \frac{d}{\sqrt{{n}^{2} - 1} - 1} ,$$
where d is the thickness of the light guiding plate and n is the refractive index of the light guiding plate.

8. The lighting system (1) according to claim 1 wherein thickness of the light guiding plate (2) is less than 10 mm.

9. The lighting system (1) according to claim 1 wherein said at least one light source (3) comprises an LED, a laser, a laser diode or the like.

10. The lighting system (1) according to claim 1 wherein the light guiding plate (2) has two curvatures (R1, R2) arranged to form the light guiding plate (2) into a saddleback surface.

11. The lighting system (1) according to claim 1 wherein the light guiding plate (2) has a plurality of curvatures (R1, R2, R3, R4, R5, R6, R7, R8).

12. The lighting system (1) according to claim 10 or 11, wherein curvatures (R1, R2, R3, R4, R5, R6, R7, R8) have the same radius and are arranged to form the light guiding plate (2) into a periodic shape.

13. The lighting system according to claim 1, wherein thickness of the light guiding plate is less than 2 mm.

14. The lighting system according to claim 10, wherein the have the same radius and are arranged to form the light guiding plate into a substantially sinusoidal shape
